(19) United States
(12) Patent Application Publication
(10) Pub. No.: US 2008/0211291 A1
(43) Pub. Date: Sep. 4, 2008

(54) HUB FOR A SPOKED BICYCLE WHEEL AND RELATED SPOKED WHEEL

(75) Inventor: Mario Meggiolan, Creazzo (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.r.l., Vicenza (IT)

(21) Appl. No.: 11/965,944

(22) Filed: Dec. 28, 2007

(30) Foreign Application Priority Data
Dec. 29, 2006 (IT) MI2006A002535

(51) Int. Cl. B60B 1/00

(52) U.S. Cl. 301/58

(57) ABSTRACT

A hub for a spoked bicycle wheel has at least one seat for inserting and housing an end portion of a spoke. This at least one seat has a notch shaped for the insertion of a spoke in a different direction from a longitudinal direction of the seat, and surfaces for stopping the spoke both in both ways of a direction of a rotation axis of the hub, and in both ways of a second direction perpendicular both to the axial direction and to the longitudinal direction of the seat. The hub, due to the configuration of the notch, allows the spoke to be connected thereto without having to unthread it along its entire length and, because of the surfaces for stopping the seat, allows the wheel to be provided with increased stiffness. Such a hub can also be used with a spoked bicycle wheel.

### FIELD OF INVENTION

The present invention concerns a hub for a spoked bicycle wheel. The invention also concerns a spoked bicycle wheel comprising such a hub.

### BACKGROUND

As known, a bicycle wheel is mainly made up of a hub intended to be rotatably associated with the bicycle frame, a rim on which the tire is assembled, and a plurality of spokes extending and tensioned between respective seats of the hub and of the rim.

The stiffness of the wheel is particularly important, especially in the field of high-performance bicycle wheels. Indeed, a stiff wheel has many advantages, including the fact that it is more stable and easy to handle when taking bends and in more dynamic situations, and more reactive when accelerating and braking, thus improving the transmission efficiency. The spokes are by their nature flexible, and thus do not per se ensure good stiffness of the wheel.

Furthermore, in order to make it easier to assemble the wheel, hubs with open seats are also known, which allow the direct insertion of the end region of the spoke in a direction transversal to the longitudinal direction of the seat, i.e. without unthreading it along its entire length. It should be noted that, in the case of spokes that do not have a curved head, the longitudinal direction of the seat coincides with the longitudinal and tensioning direction of the spoke. Such open seats, however, do not hold the spoke sufficiently in the directions perpendicular to the longitudinal direction of the seat, for which reason the wheel does not obtain a suitable stiffness.

### SUMMARY

The invention relates to a hub for a spoked bicycle wheel including at least one seat for inserting and housing an end portion of a spoke. The at least one seat has a notch shaped for the insertion of a spoke in a different direction from a longitudinal direction of the seat. The at least one seat further includes surfaces for stopping the spoke both in both ways of an axial direction of a rotation axis of the hub, and in both ways of a second direction perpendicular both to the axial direction and to the longitudinal direction of the seat.

### BRIEF DESCRIPTION OF THE DRAWINGS

Further features and advantages of the present invention shall become clearer from the following detailed description of some preferred embodiments thereof, made with reference to the attached drawings. In such drawings:

FIG. 1 shows a bicycle wheel according to the present invention;

FIGS. 2 and 3 schematically show the deformation of the spokes of a wheel;

FIG. 4 shows a bicycle hub according to a first embodiment of the present invention, with a rotation bearing and an assembled spoke shown partially;

FIG. 5 shows a longitudinal view of the hub of FIG. 4, partially sectioned along an axial plane;

FIG. 6 is a detail of FIG. 5 in a magnified view;

FIGS. 7 and 8 are sections according to planes VII and VIII of FIG. 5;

FIG. 9 is a section according to plane IX of FIG. 8;

FIG. 10 shows a spoke particularly suitable for being assembled on a hub according to the present invention;

FIG. 11 shows an assembling step of the spoke of FIG. 10;

FIG. 12 shows the spoke of FIG. 10 in the assembled condition in the hub;

FIG. 13 shows a section carried out along plane XIII of FIG. 12;

FIG. 14 shows a section carried out along plane XIV of FIG. 12; and

FIGS. 15-21 show five further embodiments of the invention, wherein FIG. 18 is a magnified detail of the embodiment of FIG. 17, and FIG. 20 is a magnified detail of the embodiment of FIG. 19.

### DETAILED DESCRIPTION OF THE PREFERRED EMBODIMENTS

### Introduction to the Embodiments

In a first aspect thereof, the invention concerns a hub for a spoked bicycle wheel, comprising at least one seat for inserting and housing an end portion of a spoke, the at least one seat comprising a notch shaped for the insertion of a spoke in a different direction from a longitudinal direction of the seat, and surfaces for stopping the spoke both in both ways of a direction of a rotation axis of the hub, and in both ways of a second direction perpendicular both to the axial direction and to the longitudinal direction of the seat.

In the present description and in the attached claims, the expression “longitudinal direction” should be construed as the direction along which the spoke passes through the seat in the assembled configuration, and does not imply any dimensional relationship with a transversal direction of the seat.

The hub described above, due to the configuration of the notch, allows the spoke to be easily connected thereto without having to unthread it along its entire length, as it occurs in the case of spokes inserted head-first in seats only having a through hole.

Preferably, the notch is shaped for the insertion of a spoke in a direction perpendicular to the longitudinal direction of the seat.

A middle plane of the notch is sloped with respect to the axial direction and to the second direction. In this case, the side walls of the notch provide stop surfaces when the spoke is housed on the bottom of the notch. The notch can therefore by itself make up the insertion and housing seat.

It should be noted that due to the aforementioned slope of the notch, the spoke is effectively held against coming out from the notch, both in case the spoke extends in a substantially radial direction, and in case the spoke extends in a substantially tangential direction, when stressed in the axial direction and in the tangential direction in use of the wheel.

More specifically, the middle plane of the notch is sloped by an acute angle with respect to a transversal plane of the hub.

Preferably, the acute angle is between 10° and 80°, more preferably between 30° and 60°, and even more preferably between 40° and 50°.

The slope can be selected according to the direction along which greater stiffness of the spoke and thus of the wheel is preferred. If greater stiffness is desired in the axial direction, slope values close to the lower extreme of the range will be preferred, vice-versa if greater stiffness is desired in the second direction, values close to the upper extreme of the range will be preferred, while a slope selected among central values of the range shall ensure a roughly equal stiffness in both directions.

The seat can be blind in the longitudinal direction of the seat, it being wider at the blind end to allow the insertion of a head of the spoke.

Alternatively, the seat, and in particular the notch, can pass through the body of the hub in the longitudinal direction of the seat. In this way, the spoke can be inserted into the seat without particular care, and it can slide therein during assembling to ease assembling also on the rim side of the wheel.

The through seat can further comprise a cavity undercut with respect to the notch. Such an embodiment is suitable for spokes having a thin central portion, of a thickness smaller than or equal to the width of the notch, and an end portion of a thickness substantially equal to the diameter of the cavity. The spoke is inserted by passing the thin portion in the notch, and then sliding it in the longitudinal direction of the seat until the end portion is housed in the cavity, and there it is prevented from coming out from the notch, due to the undercut surfaces. It should be noted that forming the seat requires a single machine tool operation.

Preferably, in the hub according to the invention the seat, and in particular the notch, passes through the body of the hub in a longitudinal direction, and it further comprises an undercut cavity with respect to the notch.

Such an embodiment is suitable for spokes having a thin central portion, of a thickness smaller than or equal to the width of the notch, and an end portion of a thickness substantially equal to the diameter of the cavity, which is inserted as discussed above.

Preferably, the cavity is undercut with respect to the notch along its entire length, so as to avoid concentrations of tensions and limit the risk of breaking when the spoke is in the assembled configuration.

Preferably, the undercut surfaces of the seat at least partially make up the surfaces for stopping in the axial direction and/or in the second direction.

Preferably, the undercut surfaces, which prevent the spoke from coming out from the notch, are curved. Such a provision allows the concentration of the tensions of a curved, most commonly cylindrical spoke portion housed in the undercut cavity, to be further decreased.

Preferably, the seat comprises walls extending parallel to the longitudinal direction of the seat, the longitudinal direction of the seat being sloped with respect to a transversal plane of the hub.

More preferably, the slope coincides with a camber angle of the wheel.

The hub can preferably comprise at least one spoke attachment element radially protruding from the hub near to an axial end thereof, the at least one through- or blind seat being formed in the at least one spoke attachment element.

Preferably, at least two seats are formed in each spoke attachment element.

More preferably, the at least two seats formed in a same spoke attachment element extend according to angles (camber angles) that diverge from one another with respect to a transversal plane of the hub. In this way, in the spoke attachment element a resisting section of variable thickness is created, which provides a suitable strength without making the hub excessively heavier.

In order to keep the weight low, each spoke attachment element can be at least partially tapered in the radial direction. In other words, its circumferential extent can decrease from the inside towards the outside of the hub in at least one radial portion of the spoke attachment element.

More specifically, the tapering in the radial direction is obtained by the spoke attachment elements comprising opposite sloped surfaces. At least one of the ends of the cavity of the seat can open at a respective sloped surface, or the sloped surfaces can be radially outside at least one of the ends of the cavity of the seat.

Again, in order to keep the weight low, each spoke attachment element can be indented in the axial direction at least one of its opposite ends in the axial direction.

As an alternative to the provision of radially protruding spoke attachment elements, the hub, at least one axial end thereof, can comprise an annular surface, the notch of the at least one seat extending from the annular surface. Such an embodiment is useful for spokes with radial attachment.

In the various aforementioned embodiments, the longitudinal direction of the seat can be substantially radial or substantially tangential.

In a second aspect thereof, the invention concerns a spoked bicycle wheel comprising a hub as described above.

In a preferred embodiment of the wheel, the at least one seat of the hub passes through the body of the hub in the longitudinal direction of the seat, a middle plane of the notch of the at least one seat is sloped by an acute angle with respect to a transversal plane of the hub, and a spoke comprising a flattened central portion having a size smaller than the width of the notch and oriented according to a transversal plane is housed in the at least one seat.

Through such provisions, if the spoke breaks it is not able to immediately come out from the seat since its flattened portion is not oriented according to the notch, and therefore it cannot unthread.

Preferably, the spoke comprises a flattened portion in close proximity to a head thereof, the flattened portion being inserted in the notch of the seat. The spoke is not able to rotate and its flattened central portion remains oriented according to the plane that most favors the aerodynamics of the wheel.

In another embodiment of the wheel of the invention, the at least one seat of the hub passes through the body of the hub in the longitudinal direction of the seat and further comprises an undercut cavity with respect to the notch, and in the at least one seat a spoke is housed comprising a flattened central portion of a size smaller than the width of the notch and a joining collar between the flattened central portion and a head, the collar having a circular section with a diameter greater than the width L of the notch, and a flattened portion in close proximity to a head thereof, the flattened portion being inserted in the notch of the at least one seat.

The cylindrical part of the collar of the spoke is held by the undercut surfaces of the seat, while the flattened portion of the collar at least partially penetrates into the notch and prevents the spoke from rotating.

The flattened central portion of the spoke is preferably oriented substantially according to a transversal plane of the hub, the orientation being implied by the mutual orientation between the flattened central portion and the flattened portion of the collar.

Preferably, the flattened central portion of the spoke is at a distance from a head of the spoke greater than the length of the seat of the hub.

In the assembly step, this allows the spoke to be moved back in the seat away from the rim, so that it is possible to insert the end of the spoke for connection to the rim in a nipple or nut without having to bend it.

### DETAILED DESCRIPTION

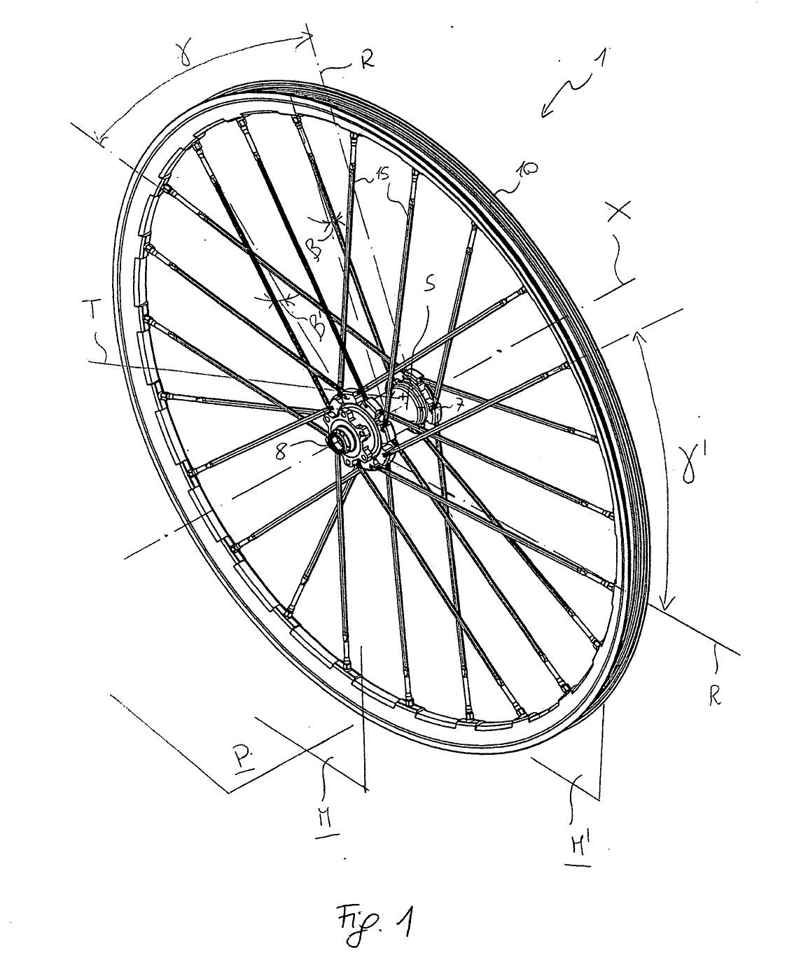

FIG. 1 shows a wheel 1, comprising a hub 5 intended to be rotatably associated with the bicycle frame, a rim 10 on which the tire is assembled, and a plurality of spokes 15 extending and tensioned between the hub 5 and the rim 10. The spokes 15 more specifically comprise a first family of spokes 15 extending close to a first axial end 7 of the hub 5, and two families of spokes 15 extending close to a second axial end 8 of the hub 5.

In the illustrated wheel 1, the projection of the direction of the spokes 15 on a plane M transversal to the rotation axis X is sloped by an angle GAMMA, GAMMA′ with respect to the radial direction R, towards a direction T tangential to the hub 5. In the field the term “spokes with tangential attachment spokes” is used, which shall be used in the rest of the description for the sake of brevity, but in no way as limiting to spokes 15 extending from the hub 5 in a direction strictly coinciding with the geometric tangent T to the hub 5. The slope angle GAMMA, GAMMA′ with respect to the radial direction R of the various families of spokes 15 is selected so that the spokes 15 of different families cross over, providing the wheel 1 with greater resistance against torsion.

In the illustrated wheel 1, moreover, the projection of the direction of the spokes 15 on an axial plane P, in other words in a plane comprising the rotation axis X, is sloped with respect to the transversal plane M, according to a camber angle BETA, BETA′. The camber angle BETA, BETA′ of the spokes of the various families of spokes 15 can be the same or different.

Finally, in the illustrated wheel 1, the spokes 15 are attached to the rim 10 at the transversal middle plane M′ and in positions equally spaced along its circumference.

A wheel according to the invention could also comprise one or more families of spokes with radial attachment to the hub 5, i.e., spokes extending in a direction the projection on a transversal plane M of which coincides with the radial direction R.

In a wheel according to the invention, moreover, the spokes 15 could be attached to the rim 10 in positions outside the transversal middle plane M′ and/or in positions not equally spaced along its circumference, so as to form groups of spokes close together.

Finally, the number of spokes 15 of each family can vary.

In other words, as shall become clear upon reading the present description, the invention applies to any type of spoking of bicycle wheels.

As stated in the introductory part of the present description, in use of a wheel 1, the spokes 15, in addition to the tensile stress, are subject to other stresses.

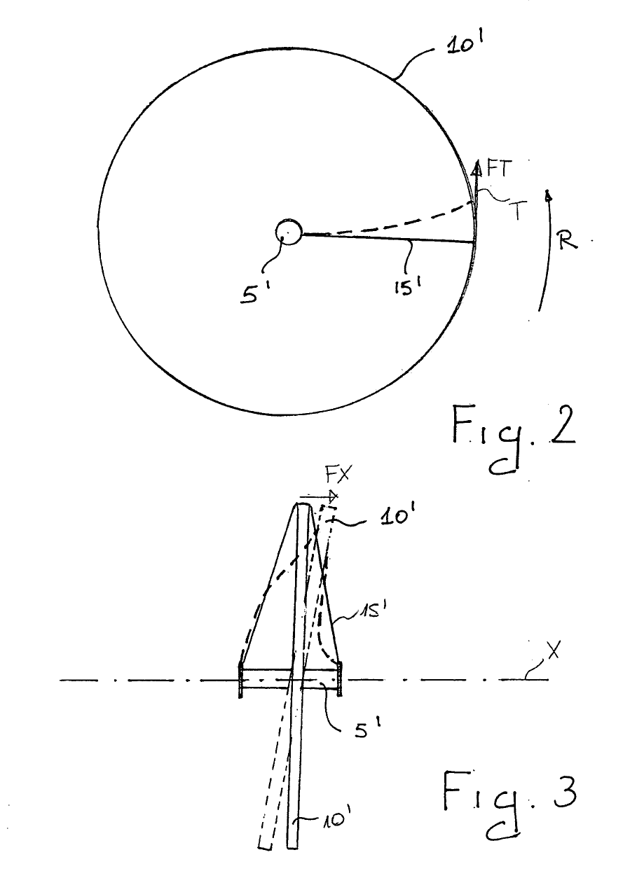

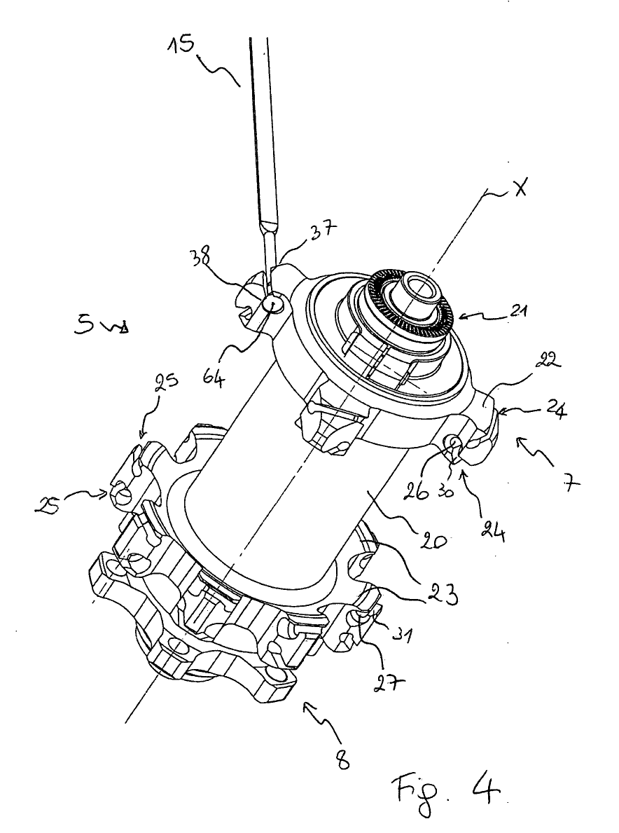

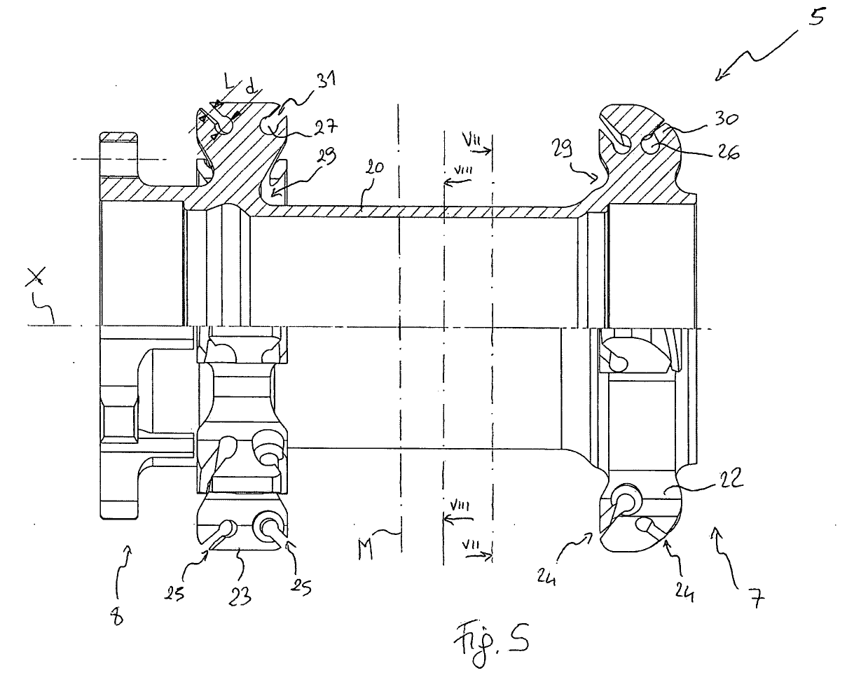

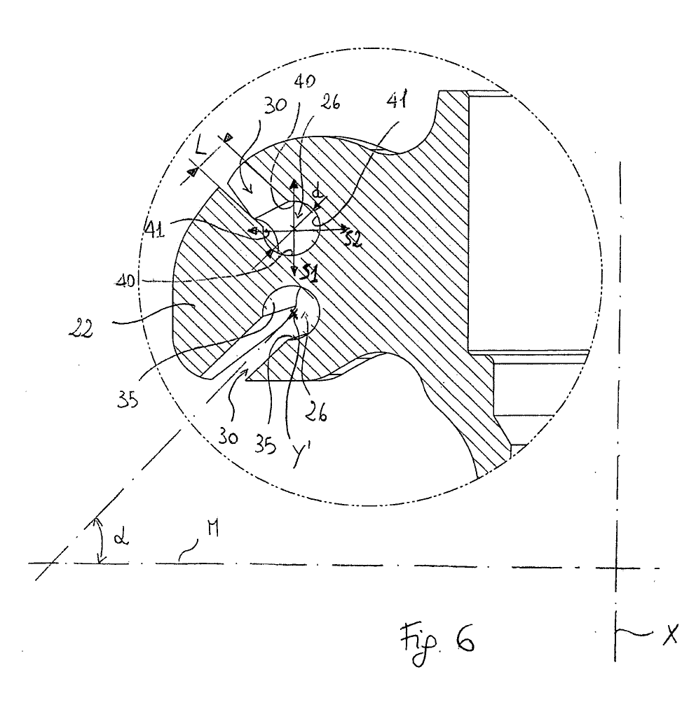

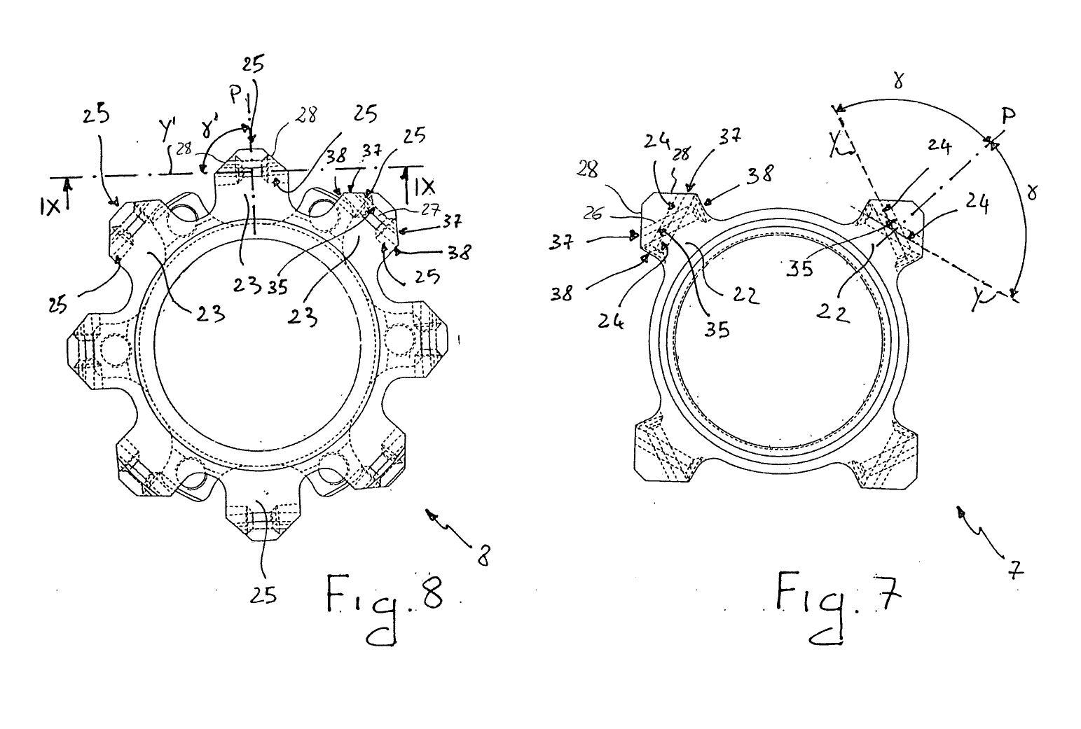

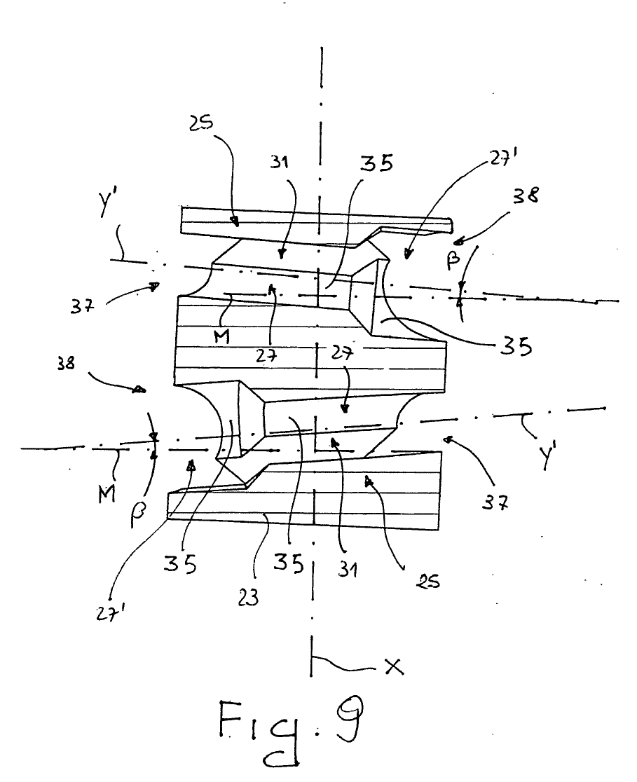

With reference to FIG. 2, during braking and acceleration of a wheel 1′, the rim 10′ has a relative rotation with respect to the hub 5′, made possible by the flexibility of the spokes 15′. The spokes 15′ are subject to stress FT substantially in the tangential direction T, deforming as shown with a dashed line.

With reference to FIG. 3, when the rim 10′ and the hub 5′ are offset to absorb an unevenness of the ground or a bump, or more simply to take a bend, the spokes 15′ are subject to stress FX substantially in the axial direction X, deforming as shown with a dashed line.

As shall be understood upon reading the present description, the hub 5 according to the present invention allows the wheel 1 to be stiffened in the presence of such stresses FT, FX, still allowing easy assembling of the spokes 15.

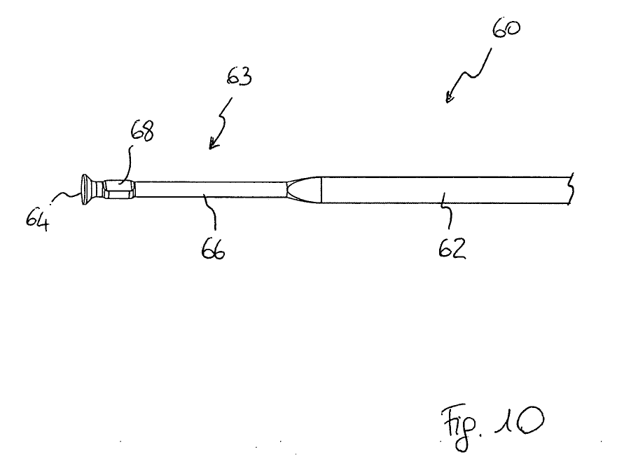

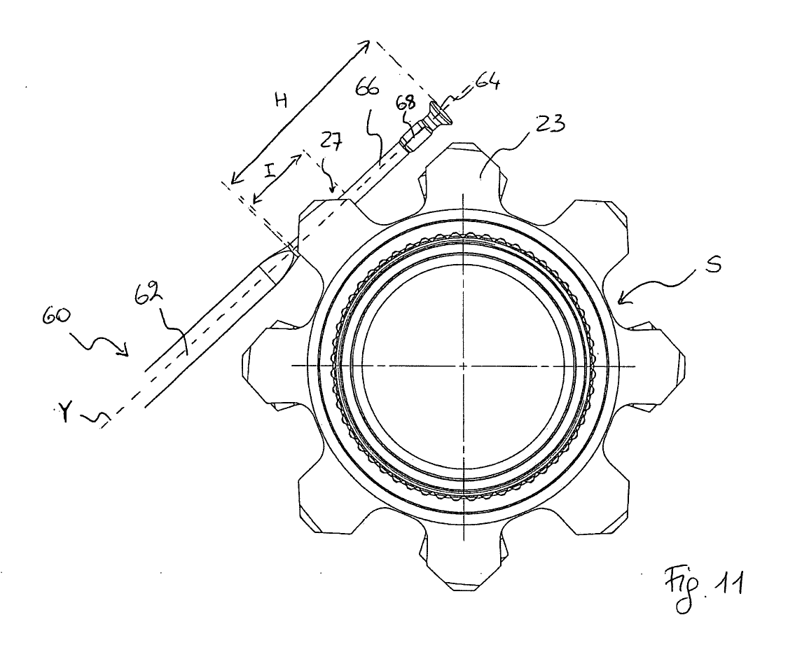

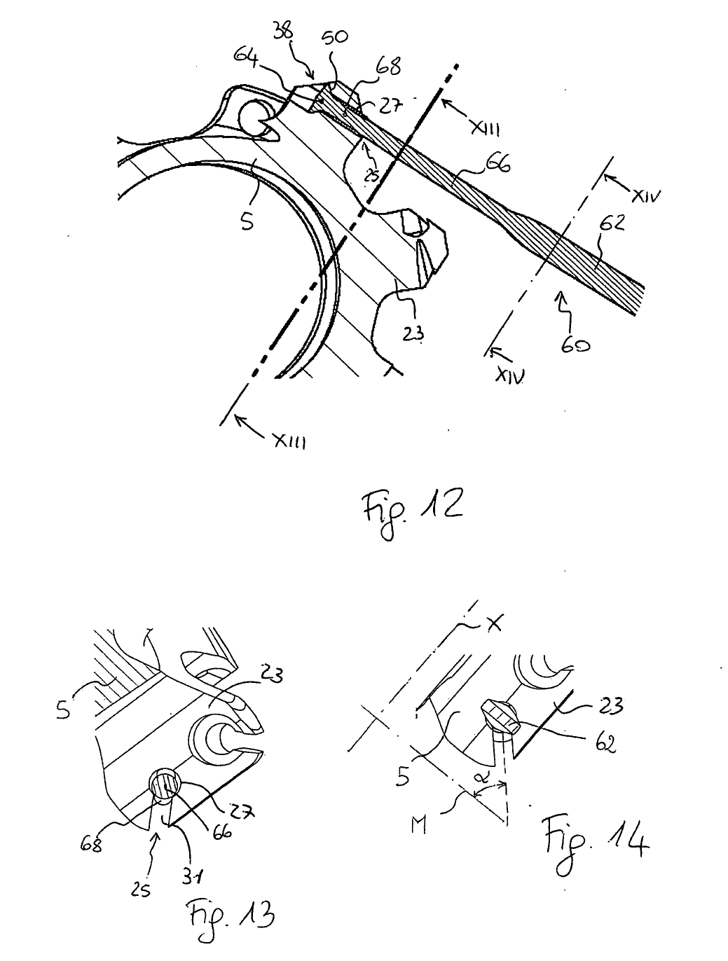

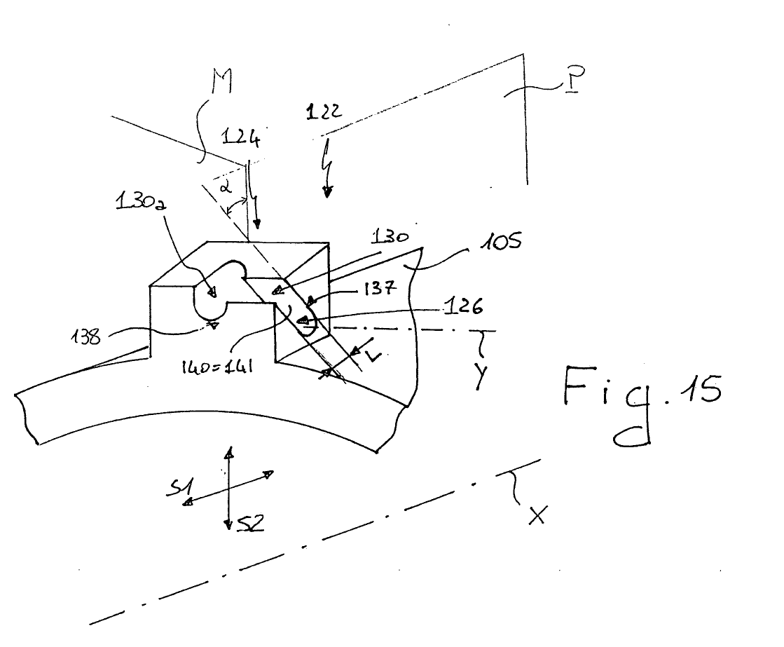

The hub 5, better illustrated in FIG. 4, comprises a substantially tubular main body 20. Through suitable bearings 21, the main body 20 of the hub 5 is rotatably associated with an inner shaft, in turn connected with the bicycle frame, to rotate about axis X.

At or near to its opposite ends 7 and 8 in the axial direction X, the hub 5 comprises a plurality of radially protruding spoke attachment elements 22, 23, in each of which two seats 24, 25 are formed, each for inserting and housing an end portion of a spoke 15. In other embodiments, each spoke attachment element 22 and/or 23 could comprise a single seat 24, 25. It should be noted that the end 8 of the hub 5 has a greater number of spoke attachment elements 23 than, more specifically twice, the number of elements 22 of the end 7, but as stated earlier this is not strictly necessary.

FIG. 5 is a longitudinal view of the hub 5, partially sectioned along an axial plane P; FIG. 6 is a section carried out according to an axial plane P of a spoke attachment element 22; FIGS. 7 and 8 are views of the opposite ends 7, 8 of the hub 5, more specifically they are sections carried out according to planes VII and VIII of FIG. 5; FIG. 9 is a view of a spoke attachment element 23 in a plane substantially tangential to the hub 5, more specifically it is a section carried out according to plane IX of FIG. 8.

With reference to such figures, each insertion and housing seat 24, 25 comprises a substantially cylindrical cavity 26, 27, communicating with the outside of the hub 5 through a notch 30, 31. The cavity 26, 27 passes through the spoke attachment element 22, 23 from a first end 37 to a second end 38. Although this is not essential, the second end 38 of the cavity 26, 27 is configured to at least partially house a widened head 64 at the free end of the spoke 15, while the cavity 26, 27 along the rest of its length has a diameter d. If the cavity 26, 27 were cylindrical along its entire length, namely without widened opening at the second end 38, the widened head 64 of the spoke 15 would project from the spoke attachment element 22, 23, it being held in the longitudinal direction Y, Y′ of the seat 24, 25 by the outer surface of the spoke attachment element 22, 23 itself. It should be noted that, in case of spokes without a curved head, the longitudinal direction Y, Y′ of the seat coincides with the longitudinal and tensioning direction of the spoke 15.

The notch 30, 31 also passes through the spoke attachment element 22, 23, and has a width L that is smaller than the diameter d of the cavity 26, 27.

Therefore, the cavity 26, 27 has undercut surfaces 35 (FIG. 6) capable of preventing the end portion of the spoke 15, having at least one transversal dimension greater than L, from coming out through the notch 30, 31. It should be noted that the undercut surfaces 35 extend along the entire length of the cavities 26, 27 (FIG. 9). The contact between the spoke 15 and the hub 5 is distributed over such extended undercut surfaces 35, for which reason concentrations of tensions are avoided and the risk of breaking is reduced.

The undercut surfaces 35 are preferably curved as illustrated, to further decrease the concentration of tensions in the assembled condition of the spoke.

The middle plane of the notch 30, 31 is sloped by an angle ALPHA (FIG. 6) with respect to a transversal plane M. The slope ALPHA of the notch 30, 31 and its width L are selected so that the cavity 26, 27 has surfaces 40 for stopping the spoke 15 in both ways of the axial direction X, as indicated by the double arrow S1, and surfaces 41 for stopping the spoke 15 in both ways of a direction S2 (double arrow S2) perpendicular both to the axial direction X and to the longitudinal direction Y, Y′ of the seat 24. In the case illustrated, in which the spoke 15 is with tangential attachment as defined above, the direction S2, is a radial direction R, neglecting the camber angle. It should be noted that near to the notch 30, 31, the cavity 26, 27 has surfaces that act simultaneously as undercut surfaces 35 and as stop surfaces 40, 41. It should also be noted that, since as illustrated the wall of the cavity 26, 27 is curved, in particular cylindrical, the surfaces indicated as 40 actually also act as stops in the direction S2, and vice-versa the surfaces indicated as 41 also act as stops in the direction S1, even if less effectively.

The illustrated angle ALPHA is 45°, but it could be any angle between 10° and 80°, preferably 30° and 60°, more preferably between 40° and 50°. The slope can be selected according to the direction in which greater stiffness of the spoke and therefore of the wheel is preferred. If greater stiffness is desired in the axial direction X or S1, slope values ALPHA close to the lower extreme of the range shall be preferred, vice-versa if greater stiffness is desired in the second direction S2, values close to the upper extreme of the range shall be preferred, while a slope selected among central values of the range will ensure a roughly equal stiffness in both directions S1, S2.

As is clear in FIGS. 7 and 8, since the spokes 15 are of the type with tangential attachment to the hub 5, as defined above, the longitudinal direction Y of the seat, in particular of the cavity 26, at the first end 7 of the hub 5 is sloped by an angle GAMMA with respect to an axial plane P passing through the center of the spoke attachment element 22, and the longitudinal direction Y′ of the seat, in particular of the cavity 27, at the second end 8 of the hub 5 is sloped by an angle GAMMA′ with respect to an axial plane P passing through the center of the spoke attachment element 23. In the case illustrated, the angle GAMMA is less than the angle GAMMA′, but in other types of spoking the two angles could be the same.

As is clear in FIG. 9, in order to provide the desired camber, the longitudinal direction Y (Y′) of the seat is sloped by a camber angle BETA (BETA′) with respect to a transversal plane M. The angles BETA and BETA′ can be the same or different.

The two seats 24 (25) of a same spoke attachment element 22 (23) diverge, for which reason the spoke attachment element 22 (23) has, between the two seats 24 (25), a resisting section of variable thickness, which allows a suitable strength to be achieved without making the hub 5 excessively heavier.

Although this is not strictly necessary, in order to keep the weight low, the spoke attachment elements 22 and 23 are tapered in the radial direction, and are indented in the axial direction.

More specifically, the tapering in the radial direction, shown in FIGS. 7 and 8, is obtained by the spoke attachment elements 22, 23 comprising opposite sloped surfaces 28, at which the first ends 37 of the cavities 26 and the first and second ends 37, 38 of the cavities 27 open. Alternatively, the opposite sloped surfaces 28 of the spoke attachment elements 22, 23 could be radially outside the cavities 26, 27.

The recess 29 in the axial direction X of the spoke attachment elements 22, 23 can be more or less accentuated and be formed on both opposite ends in the axial direction X of the spoke attachment elements 22, 23 as shown in FIG. 5, or at only one end.

FIG. 10 shows a spoke suitable for being coupled with the hub 5 of FIGS. 4-9, globally indicated with reference numeral 60. The spoke 60 comprises a flattened central portion 62 and an end region 63 on the side for connection to the hub 5. At the opposite end, not shown, the spoke 60 typically comprises a threading for coupling with a nipple or with a nut for attachment to the rim 10.

The flattened central portion 62 has a substantially rectangular section, the shorter side being of a size smaller than or equal to the width L of the notch 30, 31.

The flattened central portion 62 of the spoke 60 could be replaced by a thinner central portion, of a size less than or equal to the width L of the notch 30, 31.

In the end region 63, the spoke 60 has a head 64 and a joining collar 66 between the flattened central portion 62 and the head 64. The collar 66 preferably has a circular section, with a diameter smaller than or equal to the diameter d of the cavities 26, 27, but greater than the width L of the notch 30, 31.

The collar 66 has a flattened portion 68 in close proximity to the head 64. The cross section of the flattened portion 68 of the collar 66 is substantially rectangular, the shorter side being of a size smaller than or equal to the width L of the notch 30, 31, and the longer side being of a size greater than the diameter of the collar 66, therefore constituting a protrusion with respect to the rest of the collar 66.

The flattened central portion 62 and the flattened portion 68 of the collar 66 are mutually sloped by an angle preferably equal to the angle ALPHA formed between a middle plane M and the direction in which the notch 30, 31 extends.

In the assembling step of the spoke 60 in the hub 5, the flattened central portion 62 is initially inserted into the notch 30, 31, since the size of its shorter side is less than or equal to the width L of the notch 30, 31.

Then the spoke 60 is slid in the longitudinal Y, Y′ direction of the seat until the collar 66 partially penetrates in the cavity 26, 27 and the flattened central portion 62 is completely outside of the notch 30, 31, while the flattened portion 68 of the collar 66 has not yet entered therein.

In this position, shown in FIG. 11, the spoke 60 is rotated until the flattened portion 68 of the collar 66 is oriented with its shorter side facing the width of the notch 30, 31 and therefore it can enter into the notch 30, 31. The rotation is made possible by the fact that the diameter of the collar 66 is less than or equal to the diameter d of the cavity 26, 27. The rotation therefore takes place by the angle ALPHA or by its complement to 360°.

Preferably, the extension H of the end region 63 of the spoke 60 is greater than the length I of the cavity 26, 27 passing through the spoke attachment element 22, 23. During the assembling step this allows the spoke to be moved back in the cavity 26, 27 away from the rim 10, so that it is possible to insert the end of the spoke 60 for connection to the rim (not shown) into a nipple or nut (not shown) without having to bend it.

Finally, the spoke is slid in the longitudinal Y, Y′ direction of the seat until the head 64 abuts against a surface 50 of the hub 5.

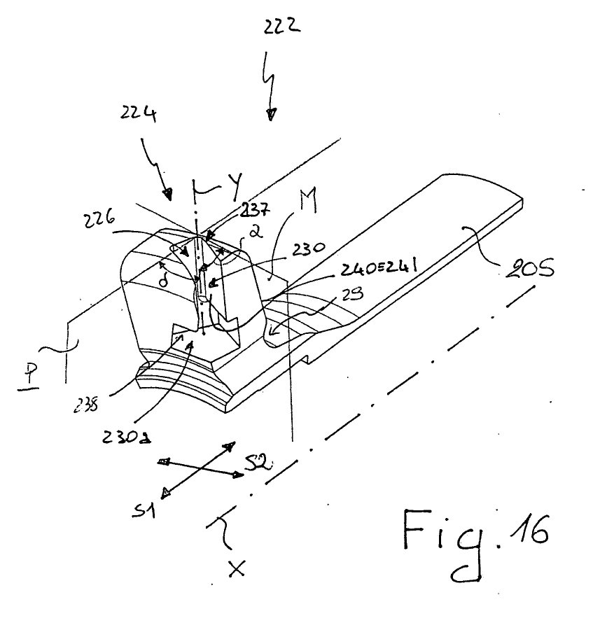

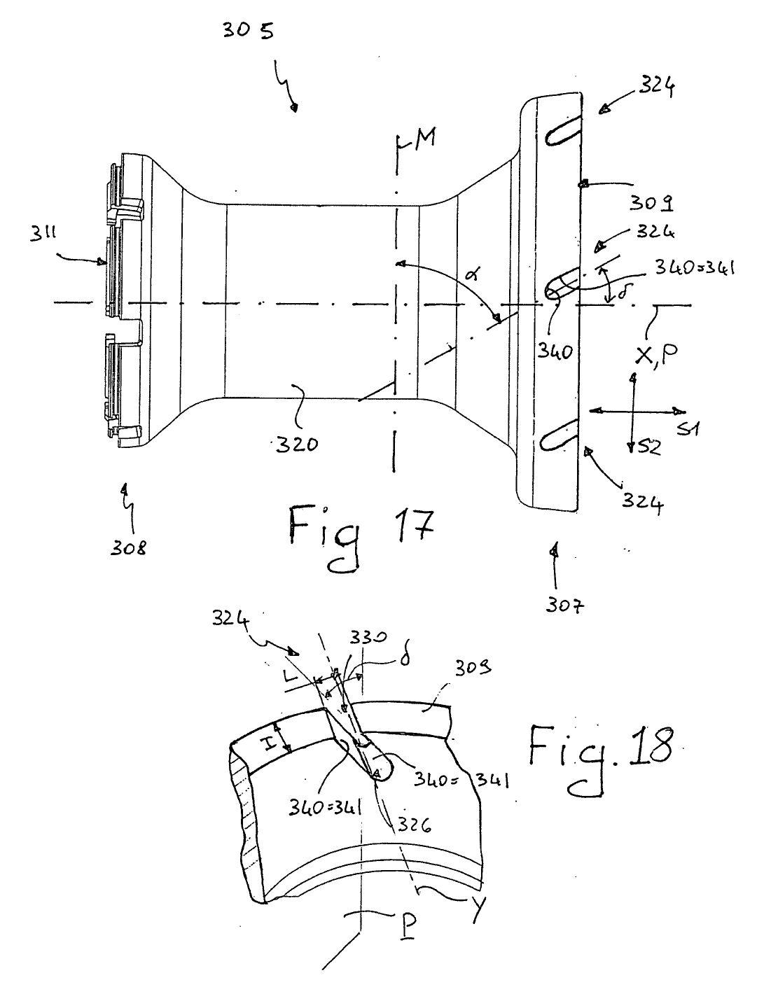

The assembled condition of the spoke 60 is shown in FIG. 12, which shows a partially removed section, carried out in a transversal plane M; in FIG. 13, which shows a section carried out along plane XIII of FIG. 12; and in FIG. 14, which shows a section carried out along plane XIV of FIG. 12.

With reference to such figures, in the assembled condition, the head 64 of the spoke 60 installs in the suitably shaped opening of the end 38 of the cavity 26, 27, or it projects outside of the hub 5 when such a shaping is absent. In any case, the hub 5 provides a stop surface 50 to hold the spoke in the longitudinal direction Y, Y′ of the seat, in the tensioning way of the spoke 60.

In the assembled condition, moreover, the flattened portion 68 of the collar 66 partially penetrates into the notch 30, 31 (FIG. 13) and prevents the rotation of the spoke 60, so that the flattened central portion 62 of the spoke 60 remains in a predetermined orientation (FIG. 14). In particular, due to the aforementioned mutual orientation between the flattened central portion 62 and the flattened portion 68 of the collar 66, looking at the wheel 1 in the axial direction, the spoke has one of the major faces of the flattened central portion 62. Such an orientation favors the aerodynamics of the wheel 1 besides providing it with a desired appearance.

It should be noted that, in the assembled condition, the flattened central portion 62 of the spoke 60 is oriented differently from the notch 30, 31. In particular, the flattened central portion 62 of the spoke 60 is oriented substantially according to a transversal plane M, while the notch 30, 31 is sloped by the angle ALPHA with respect to a transversal plane M. Consequently, in case the spoke 60 breaks, its flattened central portion 62 cannot pass immediately through the notch 30, 31, and therefore it does not accidentally come out from the seat 24, 25. Indeed, for the spoke 60 to come out from the seat 24, 25 it would have to reversely perform the movement described for assembling, and in particular to rotate until the flattened central portion 62 is precisely aligned with the notch 30, 31.

It should be understood that, as an alternative to the provision of the flattened portion 68 of the collar 66, different anti-rotation systems can be used.

The hub 5 according to the invention allows the spoke 60 to be easily connected thereto, since the provision of the notch 30, 31 allows it to be inserted in a different direction from the longitudinal direction Y, Y′, of the seat and substantially transversal thereto, namely without having to unthread it along its entire length as it occurs in the case of spokes inserted head-first in seats only having a through hole.

The hub 5, due to the abutment surfaces 35 and the stop surfaces 40, 41 of the cavity 26, 27, as well as due to the abutment surface 50 for the head 64, also holds the spoke 5, once tensioned, substantially in all directions. The stiffness of the wheel 1 in conditions of braking, acceleration, taking bends, and unevenness is therefore remarkably improved.

FIG. 15 shows a portion of an embodiment of a hub 105 wherein a spoke attachment element 122, radially protruding from the hub 105, comprises a seat 124 for inserting and housing the spoke 15 (not shown) having an insertion notch 130, the bottom of which forms a non-passing-through housing cavity 126.

The cavity 126 communicates with the outside of the hub 105 only at a first end 137, while at the second end 138 it is shaped to receive the head 64 of the spoke 15. In order to allow the insertion of the head 64 of the spoke 15 into the seat 124, the notch 130 has a portion 130a of a width equal to or greater than the head 64. Also in this case, the spoke 15 is therefore easily inserted into the hub according to a direction different from the longitudinal direction Y of the seat 124, and substantially transversal thereto, namely without the need of unthreading it along its entire length.

The seat 124 lacks undercut surfaces towards the notch 126, and therefore the hub 105 is suitable for assembling spokes of any type, in particular of cylindrical spokes without the flattened central portion 62.

The slope ALPHA of the notch with respect to a transversal plane M is selected so that the seat 124 has surfaces 140 and 141 for stopping the spoke 15 (not shown) in both ways of the axial direction X or S1, and in both ways of a direction S2 perpendicular both to the axial direction X and to the longitudinal direction Y of the seat, partially coinciding. It should be noted that also in this case, since the seat 124 is for the tangential-type attachment to the hub 105 and therefore the longitudinal direction Y of the seat is substantially tangential, the direction S2 is substantially radial.

The spoke attachment element 122 could be tapered in the radial direction and indented in the axial direction and/or comprise two or more spoke attachment seats 124.

FIG. 16 shows a portion of an embodiment of a hub 205 wherein a spoke attachment element 222, radially protruding from the hub 205, comprises a seat 224 for inserting and housing a radial attachment spoke 15 (not shown).

The seat 224 has an insertion notch 230, the bottom of which forms a non-passing-through housing cavity 226. The longitudinal direction Y of the seat 224 is substantially radial. Also in this case, the cavity 226 communicates with the outside of the hub 205 only at a first end 237, while at the second end 238 it is shaped to receive the head 64 of the spoke 15. In order to allow the insertion of the head 64 of the spoke 15 into the seat 224, the notch 230 has a portion 230a of a width equal to or greater than the head 64. Also in this case, the spoke 15 is therefore easily inserted into the hub according to a direction different from the longitudinal direction Y of the seat, and substantially transversal thereto, namely without the need of threading it along its entire length.

The seat 224 lacks undercut surfaces towards the notch 230 and therefore the hub 205 is also suitable for assembling spokes of any type, in particular cylindrical spokes without the flattened central portion 62.

The notch 226 is sloped with respect to an axial plane P by an angle DELTA, and with respect to a transversal plane M by a complementary angle ALPHA. The slope is selected so that the seat 224 has surfaces 240 and 241 for stopping the spoke 15 (not shown) in both ways of the axial direction X, as indicated by the double arrow S1, and in both ways of a direction S2 perpendicular both to the axial direction X and to the longitudinal direction Y of the seat, partially coinciding. It should be noted that in this case, since the seat 224 is for radial-type attachment to the hub 205 and therefore the longitudinal direction Y of the seat is substantially radial, the direction S2 is substantially tangential.

The spoke attachment element 222 could also be tapered in the radial direction and indented in the axial direction and/or comprise two or more spoke attachment seats 224.

FIGS. 17 and 18 show an embodiment of a hub 305 having seats 324 for radial-type insertion and housing of a respective spoke 15 (not shown).

The hub 305 comprises a substantially tubular body 320 bound at the two ends 307 and 308, opposite in the axial direction X, respectively by an annular front surface 309 and by an annular front surface 311.

Each seat 324 comprises an insertion notch 330 of a width L, extending in the body 320 from the annular front surface 309, the bottom of which defines a housing cavity 326. The notch 330 and the cavity 326 pass through the thickness I of the end 307 (FIG. 18). The notch 320 is sloped by an angle ALPHA with respect to a transversal plane M, and by a complementary angle DELTA with respect to an axial plane P. The slope is selected so that the seat 324 has surfaces 340 and 341 for stopping the spoke 15 (not shown) in both ways of the axial direction X, as indicated by the double arrow S1, and in both ways of a direction S2 perpendicular both to the axial direction X and to a longitudinal direction Y of the seat, partially coinciding. It should be noted that in this case, since the seat 324 is for radial-type attachment to the hub 305 and therefore the longitudinal direction Y of the seat is substantially radial, the direction S2 is substantially tangential.

At the end 308 of the hub 305 seats similar to, or different from, the seats 324 of the end 307, can be provided.

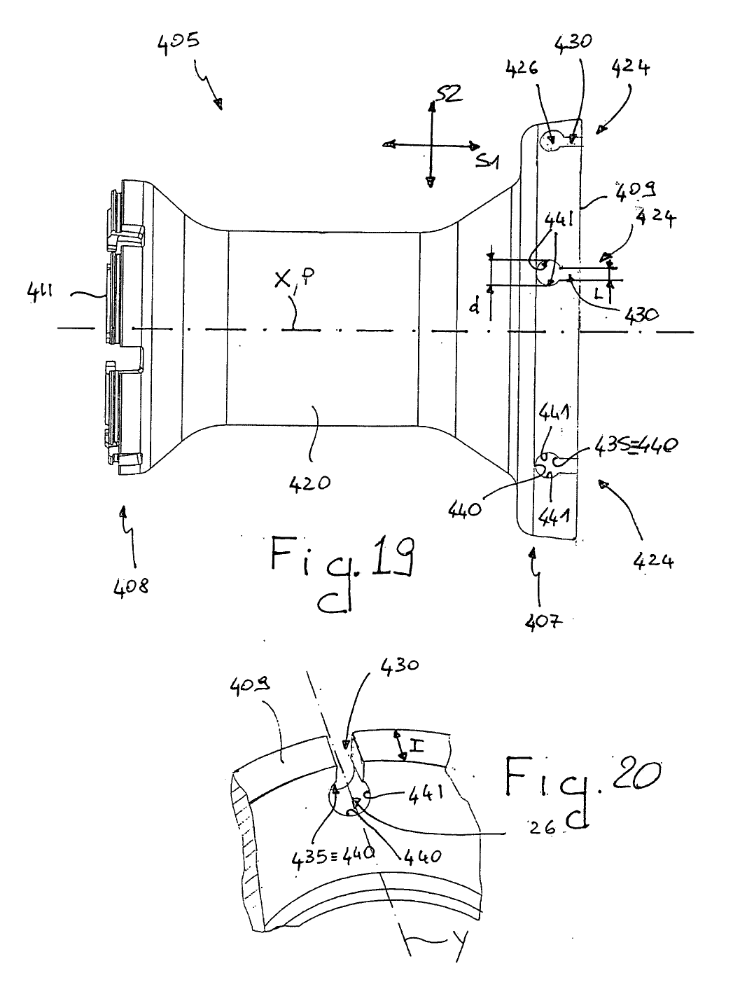

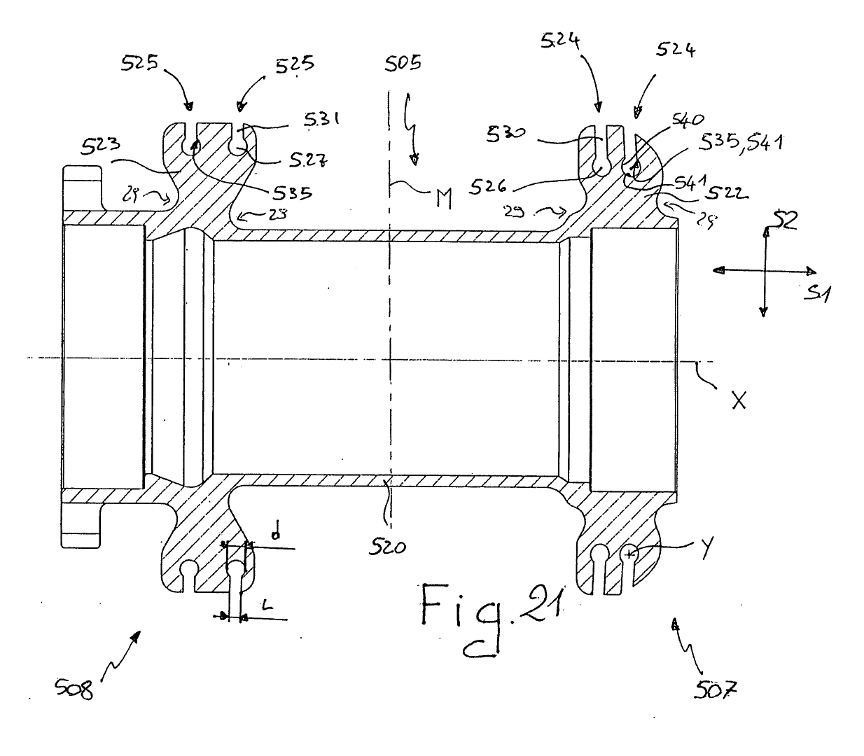

It should be noted that in general the slope ALPHA or respectively DELTA of the notch 330 suffices for the seat 324 to have surfaces 340 and 341 in both directions S1 and S2. Therefore, given that the notch 330 passes through, it is also possible to make a cavity with a diameter d greater than the width L of the notch, namely to provide for undercut surfaces similar to the surfaces 35 to further retain the spoke 15, which shall in this case be provided with a flattened central portion 62, against coming out through the notch 330, similarly to the embodiment of FIGS. 19 and 20 described hereafter.

FIGS. 19 and 20 show an embodiment of a hub 405 having seats 424 for radial-type insertion and housing of a respective spoke 15 (not shown).

The hub 405 comprises a substantially tubular body 420 bound at the two opposite ends 407 and 408 in the axial direction X by an annular front surface 409 and by an annular front surface 411, respectively.

Each seat 424 comprises an insertion notch 430 extending in the body 420 from the annular front surface 409, and a cavity 426. The notch 430 and the cavity 426 pass through the thickness I of the end 407 (FIG. 20).

The middle plane of the notch 430 is an axial plane P and the longitudinal direction Y of the seat is substantially radial. The seat 424 in any case has surfaces 440, 441 for stopping the spoke in both ways of the axial direction X, S1, and in both ways of a direction S2 perpendicular both to the axial direction X and to the longitudinal direction Y of the seat. The direction S2 is substantially tangential. The direction S1 is substantially axial, namely within the plane P of the notch, however the cavity 426 has a diameter d greater than the width L of the notch 430 for which reason the seat 424 has undercut surfaces 435 that act as the stop surfaces 440 in direction S1.

At the end 408 of the hub 405 seats similar to, or different from, the seats 424 of the end 407 can be provided.

FIG. 21 shows an embodiment of a hub 505 having seats 524, 525 for tangential-type insertion and housing of a respective spoke 15 (not shown).

The hub 505 comprises a substantially tubular body 520 near to the ends 507 and 508 of which, opposite in the axial direction X, there are radially protruding spoke attachment elements 522 and 523. A pair of seats 524, 525 are formed on each spoke attachment element 522, 523.

Each seat 524, 525 comprises a substantially cylindrical cavity 526, 527, communicating with the outside of the hub 505 through a notch 530, 531. The cavity 526, 527 and the notch 530, 531 pass through the spoke attachment element 522, 523.

The middle plane of the notch 530, 531 is a transversal plane M, and the longitudinal direction Y of the seat 524, 525 is substantially tangential. The seat 524, 525 in any case has surfaces 540, 541 for stopping the spoke in both ways of the axial direction X, S1, and in both ways of a direction S2 perpendicular both to the axial direction X and to the longitudinal direction Y of the seat. The direction S2 is, indeed, substantially radial, namely within the plane M of the notch, however the cavity 526, 527 has a diameter d greater than the width L of the notch 530, 531 for which reason the seat 524, 525 has undercut surfaces 535 that act as the stop surfaces 541 in the direction S2.

The hubs 105, 205, 305, 405, 505, due to the configurations of their seats for inserting and housing the spokes, also allow easy insertion of the spokes in a direction different from, and substantially transversal to, the longitudinal direction of the seat or tensioning direction in the case of spokes not having a curved head, and therefore without the need of unthreading them along their entire length, as well as hold the spokes, once tensioned, substantially in all directions. The stiffness of a wheel 1 having a hub 105, 205, 305, 405, 505 according to the invention in conditions of braking, acceleration, taking bends, and unevenness is therefore remarkably improved.

From the previous description it shall be understood that, on the one hand, the provision of a seat having undercut surfaces towards the insertion notch implies that it has a cavity and a notch that pass through, and it implies the provision of a flattened central portion in the spoke to allow it to be assembled; the through notch can, however, extend in a transversal or respectively axial plane.

On the other hand, the provision of a notch extending according to a plane sloped with respect to a transversal or respectively axial plane provides stop surfaces suitable for holding the spoke even without an undercut cavity, and it allows the insertion of a spoke without a flattened central portion; the seat can in this case also pass through or be blind.

A hub according to the invention could comprise seats for inserting and housing the spokes made both in radially protruding spoke attachment elements and in the thickness of one or both of its ends. It should also be noted that any number of seats, even only one, can be made in each radially protruding spoke attachment element. Those skilled in the art shall easily understand that the present invention should not however be construed as limited to the illustrated and described embodiments, rather it can be subject several changes, additions, and replacements.

What is claimed is:

1. Hub for a spoked bicycle wheel, comprising at least one seat for inserting and housing an end portion of a spoke, the at least one seat comprising a notch shaped for the insertion of a spoke in a different direction from a longitudinal direction of the seat, and surfaces for stopping the spoke both in both ways of an axial direction of a rotation axis of the hub, and in both ways of a second direction perpendicular both to the axial direction and to the longitudinal direction of the seat.

2. Hub according to claim 1, wherein the notch is shaped for the insertion of a spoke in a direction perpendicular to the longitudinal direction of the seat.

3. Hub according to claim 1, wherein a middle plane of the notch is sloped with respect to the axial direction and to the second direction.

4. Hub according to claim 3, wherein the middle plane of the notch is sloped by an acute angle with respect to a transversal plane of the hub.

5. Hub according to claim 4, wherein the acute angle is between 10° and 80°.

6. Hub according to claim 5, wherein the acute angle is between 30° and 60°.

7. Hub according to claim 6, wherein the acute angle is between 40° and 50°.

8. Hub according to claim 3, wherein the at least one seat is blind in the longitudinal direction of the seat, it being wider at the blind end.

9. Hub according to claim 3, wherein the at least one seat passes through the body of the hub in the longitudinal direction of the seat.

10. Hub according to claim 9, wherein the at least one seat further comprises a cavity undercut with respect to the notch.

11. Hub according to claim 1, wherein the at least one seat passes through the body of the hub in the longitudinal direction of the seat, and it further comprises a cavity undercut with respect to the notch.

12. Hub according to claim 10, wherein the cavity is undercut with respect to the notch along its entire length.

13. Hub according to claim 10, wherein the undercut surfaces of the seat at least partially make up the surfaces for stopping in the axial direction and/or in the second direction.

14. Hub according to claim 10, wherein the undercut surfaces of the seat are curved.

15. Hub according to claim 1, wherein the seat comprises walls extending parallel to the longitudinal direction of the seat, the longitudinal direction of the seat being sloped with respect to a transversal plane of the hub.

16. Hub according to claim 15, wherein the slope coincides with a camber angle of the wheel.

17. Hub according to claim 1, further comprising at least one spoke attachment element radially protruding from the hub near to an axial end thereof, the at least one seat being formed in the at least one spoke attachment element.

18. Hub according to claim 17, wherein in each spoke attachment element at least two seats are formed.

19. Hub according to claim 18, wherein the at least two seats formed in a same spoke attachment element extend according to camber angles diverging from each other with respect to a transversal plane of the hub.

20. Hub according to claim 17, wherein each spoke attachment element is at least partially tapered in the radial direction.

21. Hub according to claim 20, wherein each spoke attachment element comprises opposite sloped surfaces, at which at least one of the ends of a cavity of the seat opens.

22. Hub according to claim 21, wherein each spoke attachment element comprises opposite sloped surfaces radially outside at least one of the ends of the cavity of the seat.

23. Hub according to claim 17, wherein each spoke attachment element is indented in the axial direction at least one of its opposite ends in the axial direction.

24. Hub according to claim 1, further comprising, at least one of its axial ends, an annular surface, the notch of the at least one seat extending from the annular surface.

25. Hub according to claim 1, wherein the longitudinal direction of the at least one seat is substantially tangential.

26. Hub according to claim 1, wherein the longitudinal direction of the at least one seat is substantially radial.

27. Spoked bicycle wheel, comprising a hub according to claim 1.

28. Wheel according to claim 27, wherein the at least one seat of the hub passes through the body of the hub according to a longitudinal direction, a middle plane of the notch of the at least one seat is sloped by an acute angle with respect to a transversal plane of the hub and in the at least one seat a spoke is housed comprising a flattened central portion of a size smaller than a width of the notch and oriented according to a transversal plane.

29. Wheel according to claim 28, wherein the spoke comprises a flattened portion in close proximity to a head thereof, the flattened portion being inserted in the notch of the at least one seat.

30. Wheel according to claim 27, wherein the at least one seat of the hub passes through the body of the hub in a longitudinal direction of the seat and further comprises a cavity undercut with respect to the notch, and in the at least one seat a spoke is housed comprising a flattened central portion of a size smaller than the width of the notch and a joining collar between the flattened central portion and a head, the collar having a circular section with a greater diameter than the width of the notch and a flattened portion in close proximity to a head thereof, the flattened portion being inserted in the notch of the at least one seat.

31. Wheel according to claim 30, wherein the flattened central portion of the spoke is oriented substantially according to a transversal plane of the hub, the orientation being implied by the mutual orientation between the flattened central portion and the flattened portion of the collar.

32. Wheel according to claim 28, wherein the flattened central portion of the spoke is at a distance from a head of the spoke greater than a length of the seat of the hub.

33. A hub for a spoked bicycle wheel, the hub comprising at least one seat for receiving and housing an end portion of a spoke, the at least one seat comprising:
a notch shaped for the insertion of a spoke in a different direction from a longitudinal direction of the seat; and
surfaces for stopping the spoke both in both ways of an axial direction of a rotation axis of the hub, and in both ways of a second direction perpendicular both to the axial direction and to the longitudinal direction of the seat.

34. A hub for a spoked bicycle wheel, the hub comprising:
an axial direction of a rotation axis;
a second direction perpendicular to the axial direction; and
at least one seat for receiving and housing an end portion of a spoke, the at least one seat being sloped with respect to the axial direction and to the second direction.

35. A hub for a spoked bicycle wheel, the hub comprising:
an axial direction of a rotation axis;
a second direction perpendicular to the axial direction; and
at least one seat for receiving and housing an end portion of a spoke, the at least one seat comprising:
a longitudinal direction;
a notch shaped for the insertion of a spoke in a different direction from the longitudinal direction, the notch comprising a middle plane; and
surfaces for stopping the spoke both in both ways of the axial direction of the rotation axis of the hub, and in both ways of the second direction perpendicular both to the axial direction and to the longitudinal direction of the seat,
wherein the middle plane of the notch is sloped with respect to the axial direction and to the second direction.

36. A hub for a spoked bicycle wheel, the hub comprising:
an axial direction of a rotation axis;
a transversal plane; and
at least one seat for receiving and housing an end portion of a spoke, the at least one seat comprising:
a longitudinal direction; and
walls extending parallel to the longitudinal direction of the seat, the longitudinal direction of the seat being sloped with respect to the transversal plane of the hub.

37. A bicycle wheel hub comprising:
an axis of rotation;
a plane that is perpendicular to the axis; and
at least one notched seat comprising:
a middle plane that is sloped with respect to the axis; and
a longitudinal direction,
the at least one notched seat receives a spoke having an end portion that complements the at least one notched seat;
the complementary configuration prevents rotation of the end portion within the notched seat and positions the spoke at an acute angle of between 10° and 80° with respect to the plane.

38. The hub according to claim 37, wherein the notch in the at least one seat is shaped so that insertion of a spoke is in a direction perpendicular to the longitudinal direction of the seat.

39. A hub for a spoked bicycle wheel, the hub comprising:
at least one spoke attachment element protruding from the hub in a radial direction, the at least one spoke attachment element being at least partially tapered in the radial direction.

40. A hub for a spoked bicycle wheel, the hub comprising:
at least one spoke attachment element protruding from the hub in a radial direction, the at least one spoke attachment element being indented in an axial direction of a rotation axis of the hub at least one of its opposite ends in the axial direction.

41. Spoked bicycle wheel comprising:
a hub comprising at least one seat, the at least one seat comprising a notch and a cavity undercut with respect to the notch,
and a spoke comprising:
a head,
a flattened central portion of a size smaller than a width of the notch and oriented according to a transversal plane,
a flattened portion in close proximity to the head, the flattened portion being inserted in the notch of the at least one seat.
